(19) United States
(12) Patent Application Publication
(10) Pub. No.: US 2010/0060406 A1
(43) Pub. Date: Mar. 11, 2010

(54) SMALL-SIZED SURFACE-MOUNTED FUSE AND METHOD OF MANUFACTURING THE SAME

(75) Inventors: Young Sun Kim, Busan (KR); Gyu Jin Ahn, Ulsan (KR); Doo Won Kang, Ulsan (KR); Mi Young Kim, Busan (KR); Hee Kwon Son, Busan (KR); Sang Joon Jin, Busan (KR)

Correspondence Address: LADAS & PARRY, 5670 WILSHIRE BOULEVARD, SUITE 2100, LOS ANGELES, CA, 90036-5679, US

(73) Assignee: SMART ELECTRONICS INC., Ulsan (KR)

(21) Appl. No.: 12/304,691

(22) PCT Filed: Jun. 16, 2006
(86) PCT No.: PCT/KR2006/002329

§ 371 Date: Aug. 4, 2009

(51) Int. Cl. H01H 85/04; H01H 69/02

(52) U.S. Cl. 337/187; 29/623

(57) ABSTRACT

A small-sized surface-mounted fuse and a method of manufacturing the same. A fusing element, separated from a winding member, is connected to lead wires by arc welding instead of soldering. Consequently, the present invention has the effect of improving fusing characteristics and productivity while reducing the defective rate and manufacturing costs. To this end, the manufacturing method according to the present invention comprises winding a fusing element predetermined winding turns on a winding member having a predetermined length, cutting both ends of the fusing element wound the predetermined winding turns on the winding member, separating the fusing element having the cut ends from the winding member, pressing the upper ends of lead wires 11 inserted through two through-holes formed at a base while being spaced a predetermined distance from each other such that the upper ends have predetermined areas, respectively, putting the ends of the fusing element on the pressed upper ends of the lead wires, connecting the ends of the fusing element to the upper ends of the lead wires by arc welding, and covering the base with a cover.

### TECHNICAL FIELD

The present invention relates to a small-sized surface-mounted fuse, and, more particularly, to a small-sized surface-mounted fuse that is mounted to the surface of a printed circuit board of an electric product, the small-sized surface-mounted fuse having a fusing element easily fusible when excessive current is supplied to the printed circuit board, for interrupting excessive current flow to the printed circuit board to prevent components of the printed circuit board from being burnt, thereby preventing circuits of the printed circuit board from being damaged. The present invention also relates to a method of manufacturing the same.

### BACKGROUND ART

Generally, abnormally high voltage may be applied to communication devices connected to telephone circuits, for example, when the communication devices are supplied with surge current due to induced lightning or a telephone line comes into contact with a power line. For this reason, it is necessary that fuses used for communication devices have not only high current-interrupting characteristics for safely interrupting current causing the communication devices to be disabled but also high time-lag characteristics for preventing the fuses from being fused by surge current due to induced lightning.

As communication devices become increasingly miniaturized, such high current-interrupting characteristics and high time-lag characteristics are required even for small-sized surface-mounted fuses.

As shown in FIG. 1, a conventional small-sized surface-mounted fuse is manufactured by inserting a fusing element 2 wound on a supporting member 1 into ring-shaped fixing parts 4a formed at the ends of lead wires 4 inserted through a base 3, and then soldering the fusing element 2 to the lead wires 4.

Specifically, the fusing element 2 is wound on the supporting member 1, which is made of glass fiber, and then the fusing element 2 is cut to a predetermined length together with the supporting member 1 by a cutter while being wound on the supporting member 1. After both ends of the supporting member 1 are inserted into the fixing parts 4a of the lead wires 4, respectively, both ends of the fusing element 2 are securely attached to the fixing parts 4a of the lead wires 4 by soldering. In this way, the fusing element 2 is connected to the lead wires 4.

As described above, the fusing element 2 is joined to the lead wires 4 by soldering in the conventional small-sized surface-mounted fuse. In the conventional small-sized surface-mounted fuse, however, it is necessary for the fuse to pass through a high-temperature lead bath when the fuse is mounted to the surface of the printed circuit board. As a result, solder 5 between the fusing element 2 and the lead wire 4 is molten due to high temperature of the lead bath, and therefore, connection between the fusing element 2 and the lead wires 4 may be deteriorated. Furthermore, lead is a toxic material, harmful to the environment, and therefore, may contaminate the environment.

Also, the solder 5 molten during soldering may flow to the fusing element 2 along the supporting member 1, and the solder 5 may connect windings of the fusing element 2 to each other. As a result, the total length of the fusing element 2 is decreased, and therefore, fusing characteristics of the fusing element 2 are deteriorated.

Also, the fusing element 2 is successively wound on the supporting member 1, which is made of glass fiber having a predetermined diameter, and is then cut to a predetermined length by a cutter. Consequently, the length of the fusing element 2 wound on the supporting member 1 may be increased or decreased whenever the fusing element 2 is cut or depending on who cuts the fusing element 2, and therefore, the length of the wound fusing element 2 may not be uniform. As a result, resistance value distribution, which decides fusing characteristics, is widened, and the number of winding turns of the fusing element 2, which also decides fusing characteristics, is not accurate, and therefore, fusing distribution is widened. Consequently, fusing characteristics of products are deteriorated.

Also, the fusing element 2 wound on the supporting member 1 is soldered to the lead wires 4 in the conventional small-sized surface-mounted fuse. Consequently, it is necessary that the lead wires 4 be provided with additional fixing parts used to fix the supporting member 1 to the lead wires 4. Furthermore, connection by soldering between the fusing element 2 and the lead wires 4 is difficult due to the supporting member 1, which is means merely for supporting the fusing element 2 and has no effect on the fusing characteristics. As a result, the supporting member 1 is also soldered to the lead wires 4 together with the fusing element 2, and therefore, the solder 5 flows to the fusing elements. Consequently, the defective rate is increased, and therefore, productivity is deteriorated.

### DISCLOSURE OF INVENTION

### Technical Problem

Therefore, it is an aspect of the invention to provide a small-sized surface-mounted fuse that is capable of improving fusing characteristics and productivity while reducing the defective rate and manufacturing costs.

It is another aspect of the invention to provide a method of manufacturing a small-sized surface-mounted fuse that is capable of improving fusing characteristics and productivity while reducing the defective rate and manufacturing costs.

### Technical Solution

Therefore, it is an aspect of the invention to provide a small-sized surface-mounted fuse that is capable of improving fusing characteristics and productivity while reducing the defective rate and manufacturing costs.

It is another aspect of the invention to provide a method of manufacturing a small-sized surface-mounted fuse that is capable of improving fusing characteristics and productivity while reducing the defective rate and manufacturing costs.

In accordance with one aspect, the present invention provides a method of manufacturing a small-sized surface-mounted fuse, comprising: winding a fusing element predetermined winding turns on a winding member having a predetermined length; cutting both ends of the fusing element wound the predetermined winding turns on the winding member; separating the fusing element having the cut ends from the winding member; pressing the upper ends of lead wires 11 inserted through two through-holes formed at a base while being spaced a predetermined distance from each other such that the upper ends have predetermined areas, respectively; putting the ends of the fusing element on the pressed upper ends of the lead wires; connecting the ends of the fusing element to the upper ends of the lead wires by arc welding; and covering the base with a cover.

Preferably, the ends of the fusing element are cut such that the cut ends of the fusing element are directed in the same direction.

In accordance with another aspect, the present invention provides a small-sized surface-mounted fuse comprising: a base having two through-holes formed therethrough; lead wires inserted through the through-holes of the base, respectively, the lead wires being provided with pressed parts, respectively, the pressed parts being formed by pressing predetermined portions of the upper ends of the lead wires such that the pressed portions have predetermined areas, respectively; and a fusing element connected between the upper ends of the lead wires, wherein the ends of the fusing element are connected to the corresponding pressed parts formed at the upper ends of the lead wires by arc welding.

### ADVANTAGEOUS EFFECTS

The present invention provides a small-sized surface-mounted fuse, in which the fusing element, separated from the winding member, is connected to the lead wires by arc welding instead of soldering. Consequently, the present invention has the effect of improving fusing characteristics and productivity while reducing the defective rate and manufacturing costs.

Also, the present invention provides a small-sized surface-mounted fuse, in which the fusing element is connected to the lead wires by arc welding, not soldering. That is, the solder is not used in accordance with the present invention. Consequently, the present invention has the effect of minimizing generation of a toxic material, harmful to the environment.

### DESCRIPTION OF DRAWINGS

FIG. 1 is a perspective view showing a conventional small-sized surface-mounted fuse;

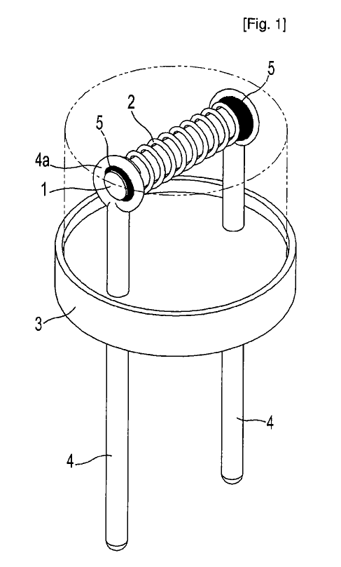

FIG. 2 is a perspective view showing a small-sized surface-mounted fuse according to an embodiment of the present invention;

FIG. 3 is a front view, in section, of the small-sized surface-mounted fuse shown in FIG. 2;

FIG. 4 is a side view, in part, of the small-sized surface-mounted fuse shown in FIG. 2;

FIG. 5 is a flow chart illustrating a method of manufacturing a small-sized surface-mounted fuse according to an embodiment of the present invention; and

FIGS. 6 to 9 are views illustrating detailed operations of the fuse manufacturing method illustrated in FIG. 5

### BEST MODE

Reference will now be made in detail to the embodiment of the present invention. The embodiment is described below to explain the present invention by referring to the figures.

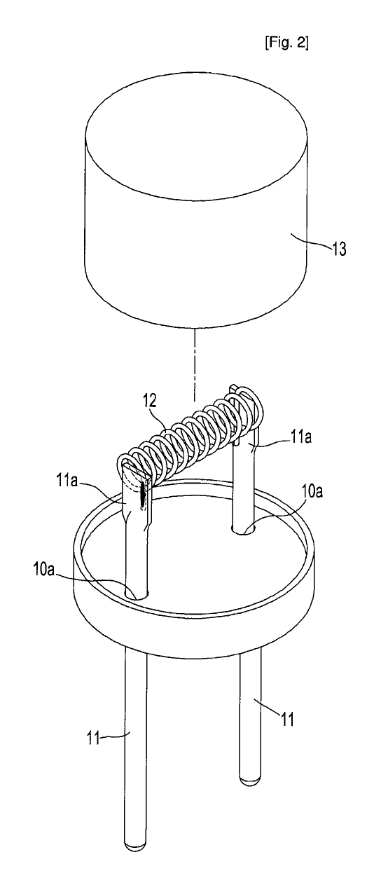

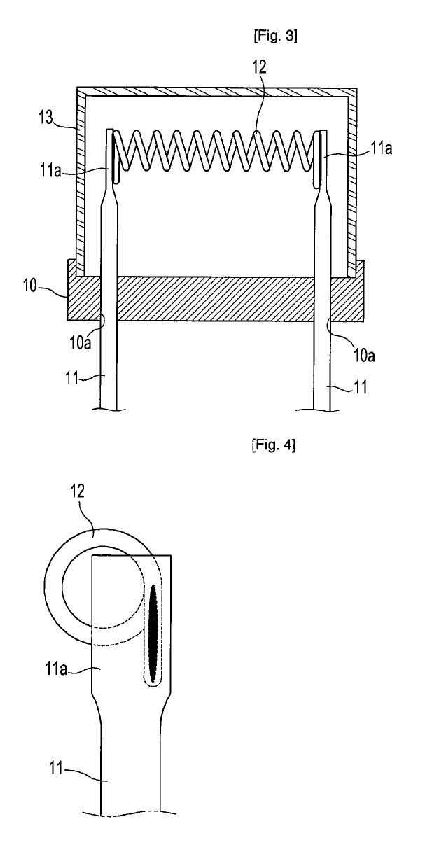

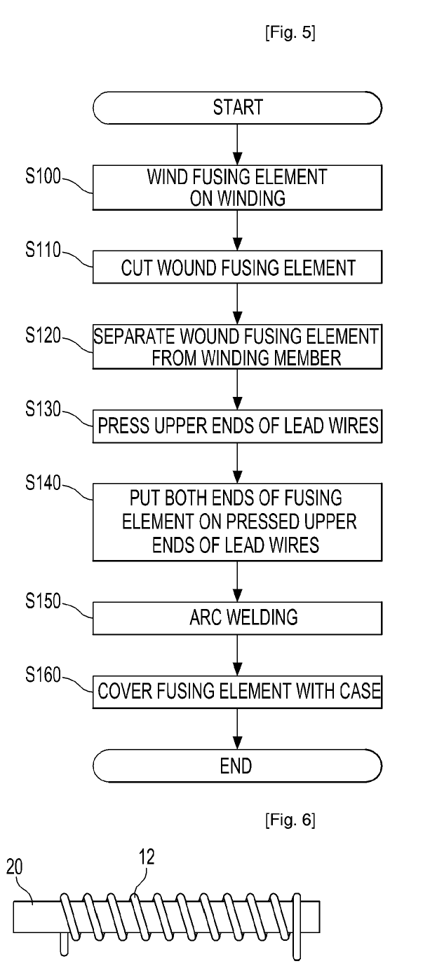

FIG. 2 is a perspective view showing a small-sized surface-mounted fuse according to an embodiment of the present invention, FIG. 3 is a front view, in section, of the small-sized surface-mounted fuse shown in FIG. 2, and FIG. 4 is a side view, in part, of the small-sized surface-mounted fuse shown in FIG. 2.

As shown in FIG. 2, the small-sized surface-mounted fuse comprises: a base 10 having two through-holes 10a formed therethrough; lead wires 11 inserted through the through-holes 10a of the base 10, respectively; a fusing element 12 connected between the upper ends of the lead wires 11; and a case 13 attached to the base 10 while the fusing element 12 is connected to the lead wires 11.

The base 10 and the case 13 are provided with protrusions (not shown) and grooves (now shown), in which the protrusions are engaged, respectively.

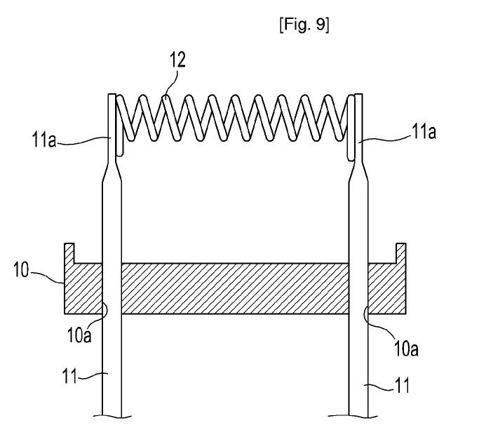

In the small-sized surface-mounted fuse according to the present invention, the fusing element 12 is wound on a winding member 20 (See FIG. 6), which is made of metal, and then the winding member 20 is removed from the fusing element 12. Thereafter, the fusing element 12 is connected to the upper ends of the lead wires 11, which are inserted through the through-holes 10a of the base 190, by arc welding. In this way, the fusing element 12 is connected to the lead wires 11.

To this end, as shown in FIG. 3, the lead wires 11 are provided with pressed parts 11a, respectively, which are formed by pressing predetermined portions of the upper ends of the lead wires 11 such that the pressed portions have predetermined areas, respectively. According to the present invention, the lead wires are not provided with additional ring-shaped fixing parts, respectively, which are necessary to fix the supporting member having the fusing element 12 wound thereon to the lead wires 11 in the conventional fuse. Consequently, a process of manufacturing the fuse is simplified, and therefore, productivity of the fuse is improved.

The fusing element 12 is wound predetermined winding turns on the winding member 20 based on a predetermined resistance value. After the fusing element 12 is wound on the winding member 20, the winding member 20 is removed from the fusing element 12, and then the fusing element 12 is connected to the lead wires 11. At this time, two arc-welding electrodes are supplied with electric current while both ends of the fusing element 12 are in contact with the pressed parts of the lead wires 11, as shown in FIG. 4, such that the fusing element 12 is connected to the lead wires 11 by arc welding. More specifically, the fusing element 12 is wound predetermined winding turns on the supporting member 20 based on a predetermined resistance value, the fusing element 12 is arranged such that both ends of the fusing element 12 are directed in the same direction, the ends of the fusing element 12 are cut by a cutter, and the fusing element 12 is connected to the lead wires 11 by arc welding while the ends of the fusing element 12 are put on the pressed parts 11a of the lead wires 11. In this way, the small-sized surface-mounted fuse according to the present invention is manufactured.

According to the present invention, the supporting member for supporting the fusing element 12 is not used as described above. Consequently, the costs necessary to prepare the supporting member, and therefore, the total manufacturing costs of the fuse are reduced. Also, the fusing element 12 is connected to the lead wires 11 by arc welding, not soldering. Consequently, the connectability between the fusing element 12 and the lead wires 11 is improved. As a result, connection between the fusing element 12 and the lead wires 11 is not deteriorated when the small-sized surface-mounted fuse passes through a high-temperature lead bath to mount the small-sized surface-mounted fuse to the surface of a printed circuit board. Consequently, the product defect rate is decreased.

A process of manufacturing the small-sized surface-mounted fuse according to the present invention will be described hereinafter in detail.

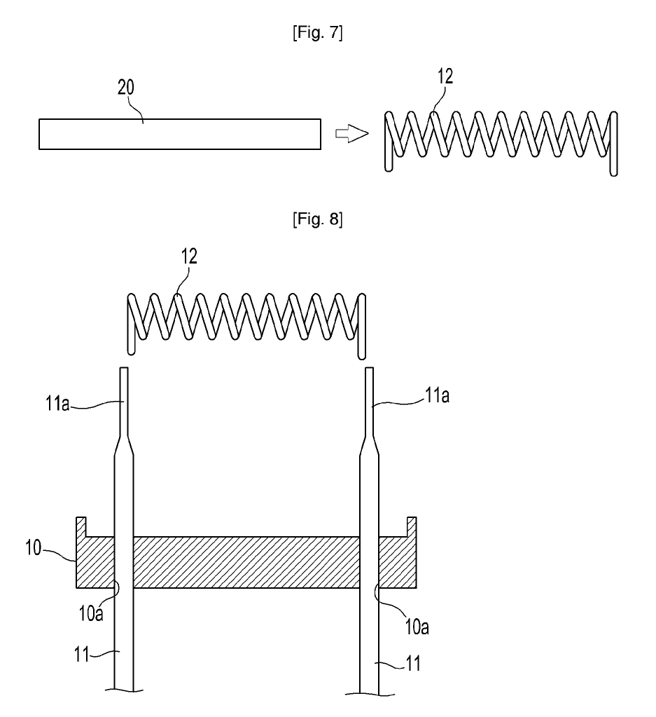

Referring to FIG. 5, the fusing element 12 is wound predetermined winding turns on the metal winding member 20 based on a predetermined resistance value in Operation S100.

In Operation S110, the fusing element 12 is arranged such that both ends of the fusing element 12 are directed in the same direction, as shown in FIG. 6, and then the ends of the fusing element 12 are cut by a cutter.

In the conventional small-sized surface-mounted fuse, the fusing element 2 is wound on the supporting member 1 made of glass fiber having a predetermined diameter, and the fusing element 2 is cut together with the supporting member 1 by a cutter. Consequently, the length of the fusing element 2 wound on the supporting member 1 may be increased or decreased whenever the fusing element 2 is cut, and therefore, resistance value distribution, which decides fusing characteristics, is widened. Also, the number of winding turns of the fusing element 2, which also decides fusing characteristics, is not accurate, and therefore, fusing distribution is widened. Consequently, fusing characteristics of products are deteriorated.

In the small-sized surface-mounted fuse according to the present invention, on the other hand, the supporting member made of glass fiber is replaced with the metal winding member 20, and the fusing member 12 is cut while the metal winding member 20 is removed from the fusing member 12. As a result, the diameter of the wound fusing element 12 may be adjusted to 0.5-1 mm. Also, the fusing element 12 is individually wound on the winding member 20. As a result, the number of winding turns may be freely adjusted to 8-15 turns. Consequently, the resistance value and the number of winding turns, which decide the fusing characteristics of the small-sized surface-mounted fuse, are adjusted more accurately than the conventional small-sized surface-mounted fuse, and therefore, the fusing characteristics of products are improved.

Specifically, the fusing element is continuously wound on the supporting member made of glass fiber having a predetermined diameter, is cut to a predetermined length by a cutter, and is then fixed to the lead wires by soldering in the conventional small-sized surface-mounted fuse. In the small-sized surface-mounted fuse according to the present invention, on the other hand, the fusing element 12 is individually wound on the metal winding member 20, is separated from the metal winding member 20, and is then fixed to the lead wires by arc welding, which will be described below in detail. In the conventional small-sized surface-mounted fuse, the fusing element 2 is connected to the lead wires only by soldering due to the presence of the supporting member made of glass fiber. In the conventional small-sized surface-mounted fuse, on the other hand, the fusing element 12 is connected to the lead wires by arc welding.

In Operation S120, the fusing element 12 having the cut ends is separated from the metal winding member 20, as shown in FIG. 7.

To easily connect the fusing element 12, which has been separated from the metal winding member 20, to the lead wires 11 by are welding, which will be described below, predetermined portions of the upper ends of the lead wires 11, which are inserted through the through-holes 10a of the base 10, are pressed by a press to form pressed portions 11a having predetermined areas, respectively, as shown in FIG. 8 (Operation S130).

In Operation S140, both ends of the fusing element 12, which is separated from the metal winding member 20 in Operation S120, are put on the pressed parts 11a of the lead wires 11, which are pressed in Operation S130, as shown in FIG. 9.

In Operation S150, two arc-welding electrodes are disposed at the positions where the ends of the fusing element 12 are put on the pressed parts 11a of the lead wires 11, respectively, and are then supplied with electric current such that the ends of the fusing element 12 are securely attached to the pressed parts 11a of the lead wires 11, respectively. In this way, the fusing element 12 is connected to the lead wires 11 by arc welding.

Finally, the base 10 is covered with a case 13 (Operation S160). Specifically, the case 13 is put on the base 10, and is then securely fixed to the base 10 by the engagement of the protrusions formed at the base 10 into the grooves formed at the case 13, respectively. In this way, the process of manufacturing the small-sized surface-mounted fuse is completed.

### INDUSTRIAL APPLICABILITY

As apparent from the above description, the fusing element, separated from the winding member, is connected to the lead wires by arc welding instead of soldering. Consequently, the present invention has the effect of improving fusing characteristics and productivity while reducing the defective rate and manufacturing costs.

Also, the fusing element is connected to the lead wires by arc welding, not soldering. That is, the solder is not used in accordance with the present invention. Consequently, the present invention has the effect of minimizing generation of a toxic material, harmful to the environment.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of manufacturing a small-sized surface-mounted fuse, comprising:
winding a fusing element predetermined winding turns on a winding member having a predetermined length;
cutting both ends of the fusing element wound the predetermined winding turns on the winding member;
separating the fusing element having the cut ends from the winding member;
pressing the upper ends of lead wires inserted through two through-holes formed at a base while being spaced a predetermined distance from each other such that the upper ends have predetermined areas, respectively;
putting the ends of the fusing element on the pressed upper ends of the lead wires;
connecting the ends of the fusing element to the upper ends of the lead wires by arc welding; and
covering the base with a cover.

2. The method according to claim 1, wherein the ends of the fusing element are cut such that the cut ends of the fusing element are directed in the same direction.

3. A small-sized surface-mounted fuse comprising:
a base having two through-holes formed therethrough;
lead wires inserted through the through-holes of the base, respectively, the lead wires being provided with pressed parts, respectively, the pressed parts being formed by pressing predetermined portions of the upper ends of the lead wires such that the pressed portions have predetermined areas, respectively; and
a fusing element connected between the upper ends of the lead wires, wherein the ends of the fusing element are connected to the corresponding pressed parts formed at the upper ends of the lead wires by arc welding.
